(19) United States
(12) Patent Application Publication
(10) Pub. No.: US 2012/0164747 A1
(43) Pub. Date: Jun. 28, 2012

(54) METHOD OF EXTRACTING PLASMA BY AGGLUTINATION OF BLOOD CELLS AND PLASMA SEPARATION DEVICE THEREFOR

(75) Inventors: YO HAN CHOI, DAEJEON (KR); KWANG HYO CHUNG, DAEJEON (KR); GUN YONG SUNG, DAEJEON (KR)

(73) Assignee: ELECTRONICS AND TELECOMMUNICATIONS RESEARCH INSTITUTE, DAEJEON (KR)

(21) Appl. No.: 13/315,494

(22) Filed: Dec. 9, 2011

(30) Foreign Application Priority Data
Dec. 23, 2010 (KR) 10-2010-0134047

(51) Int. Cl. G01N 1/34; B01D 35/00

(52) U.S. Cl. 436/175; 422/534

(57) ABSTRACT

The present invention relates to a plasma extraction method in which a complex of a blood cell-specific antibody and a protein having the ability to bind to the Fc region of the antibody is used to induce the agglutination of blood cells in blood, thereby increasing plasma separation efficiency, and to a plasma separation device therefor. According to the method, plasma can be separated from whole blood in high efficiency, and rapid plasma separation is possible, so that rapid diagnosis can be performed even with a small amount of blood.

### CROSS-REFERENCES TO RELATED APPLICATIONS

The present application claims priority under 35 U.S.C 119(a) to Korean Application No. 10-2010-0134047, filed on Dec. 23, 2010, in the Korean Intellectual Property Office, which is incorporated herein by reference in its entirety set forth in full.

### BACKGROUND

Exemplary embodiments of the present invention relate to a method of extracting plasma by agglutination of blood cells, and more particularly to a plasma extraction method in which a complex of a blood cell-specific antibody and a protein having the ability to bind to the Fc region of the antibody is used to induce the agglutination of blood cells in blood, thereby increasing plasma separation efficiency, and to a plasma separation device therefor.

Blood-based diagnosis is performed to identify proteins present in the liquid part of blood (i.e., plasma), and thus the removal of blood cells is a preceding step in blood-based diagnosis. For humans, 1 ml of blood contains more than about 5×10⁹ red blood cells and more than 5×10⁶ white blood cells, which make up more than 40% of the volume of blood. For the analysis of various biomarkers contained in plasma, the removal of blood cells which make up more than 40% of whole blood should be first performed.

In medical institutions equipped with large-scale systems, blood cells are sedimented using a centrifugation device, after which the supernatant plasma is collected and used for diagnosis. However, when such devices are not easy to use or when immediate diagnosis should be performed on a small amount of blood at site, the removal of blood cells is mostly performed using a physical filter device, and diagnosis is performed using diagnostic chips for on-site diagnosis. This filter device is based on the phenomenon in which the transfer rate of blood cells starts to become slower than that of plasma due to the three-dimensional meshwork structure of the device, after blood has been applied to a plasma filter made of paper or glass paper. Thus, a large amount of plasma still remains mixed with blood cells so that the recovery rate of plasma is reduced, and for this reason, a large amount of a blood sample is required. In addition, there is a problem in that a significant amount of time is required for complete separation of plasma from blood cells.

### SUMMARY

Accordingly, the present invention has been made in view of the problems occurring in the prior art, and it is an object of the present invention to provide a plasma extraction method in which a complex of a blood cell-specific antibody of a subject and a protein having the ability to bind to the Fc region of the antibody is used to induce the agglutination of blood cells so as to increase plasma separation efficiency, so that plasma separation can be achieved in a rapid and accurate manner.

Another object of the present invention is to provide a plasma separation device for plasma extraction.

An embodiment of the present invention relates to a plasma extraction method comprising the steps of: preparing a blood cell-specific antibody of a subject; mixing the antibody with a protein having the ability to bind to the Fc region of the antibody, thereby forming an antibody-protein complex; allowing the antibody-protein complex to react with the blood of the subject, thereby agglutinating the blood cells of the subject; and filtering the reacted blood through a filter, thereby separating plasma from the blood.

For the convenience of plasma separation, the plasma extraction method of the present invention may further comprise, after the step of forming the antibody-protein complex, a step of applying the antibody-protein complex to the inside of a device for plasma separation and injecting the subject's blood into the device so as to react with the antibody-protein complex.

In one embodiment of the present invention, the antibody may be IgG, and the protein having the ability to bind to the Fc region of the protein may be protein A, protein G, or a mixture thereof.

If the protein having the ability to bind to the Fc region of the protein is protein G, the antibody-protein complex may consist of two IgGs bound to one protein G, and if the protein is protein A, the antibody-protein complex may consist of four IgGs bound to one protein A.

Another embodiment of the present invention relates to relates to a plasma separation device comprising a fluid channel, the fluid channel comprising: a sample injection unit through which the blood of a subject is injected; a reaction unit to which a complex consisting of a blood cell-specific antibody of the subject and a protein having the ability to bind to the Fc region of the antibody is applied to induce the agglutination of blood cells; and a filter unit for filtering the blood to separate plasma from the blood.

In an embodiment of the present invention, the fluid channel comprising the sample injection unit, the reaction unit and the filter unit may be made of a plastic, glass, silicone or rubber material.

The filter unit may comprise a single layer or multilayer filter for capturing the agglutinated blood cells and passing only the plasma, in which the filter may be in the form of a porous matrix made of a paper, glass fiber, ceramic, steel or polymer material.

Also, the porous matrix may have a pore size of 10-100 μm.

In an embodiment of the present invention, the plasma separation device may further comprise, at its end, a unit for analyzing plasma biomarkers.

In an embodiment of the present invention, the plasma separation device may be in the form of a plasma separation chip.

### BRIEF DESCRIPTION OF THE DRAWINGS

The above and other aspects, features and other advantages will be more clearly understood from the following detailed description taken in conjunction with the accompanying drawings, in which:

FIG. 1 shows the configuration of a plasma separation device which is used to perform a plasma extraction method according to an embodiment of the present invention;

FIG. 2a illustrates the structure of an antibody which is used in an embodiment of the present invention;

FIG. 2b shows an antibody-protein complex consisting of two IgGs bound to one protein G according to an embodiment of the present invention;

FIG. 2c shows an antibody-protein complex consisting of four IgGs bound to one protein A according to an embodiment of the present invention; and

FIG. 3 shows a blood cell agglutination reaction according to an embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention as defined in the appended claims.

Unless specified otherwise, as used herein, the term “comprising” means that the recited elements or steps may be only part of the method or device and does not exclude additional unrecited elements or steps. Also, as used herein, the term “unit” or the like means a unit of processing at least one function or operation.

A blood extraction method according to one embodiment of the present invention comprises the steps of: preparing a blood cell-specific antibody of a subject; mixing the antibody with a protein having the ability to bind to the Fc region of the antibody, thereby forming an antibody-protein complex; allowing the antibody-protein complex to react with the blood of the subject, thereby agglutinating the blood cells of the subject; and filtering the reacted blood through a filter, thereby separating plasma from the blood.

Hereinafter, each step of the method according to the present invention will be described.

Step of Preparing Antibody

This step is a step of preparing an antibody specifically binding to the blood cell of a subject in need of diagnosis.

The subject may be an animal, including a human. Preferably, the subject is a human.

The antibody specific for the blood cell may be prepared by a conventional method known in the art. For example, the antibody that is used in the present invention may be prepared by inoculating the blood cells of a subject into the abdominal cavity of a mouse, collecting the mouse blood at a certain time after the inoculation, and separating an antibody specific for the blood cell of the subject from the collected mouse blood. Herein, the subject's blood cells that are inoculated are preferably used in a state in which they are free from plasma proteins. Also, the subject's blood cells are preferably inoculated four times or more at 2-3-week intervals in order to form a sufficient amount of antibody.

Moreover, the animal that is used to prepare the antibody may be, in addition to a mouse, a rabbit, a goat, a horse, a cow or the like.

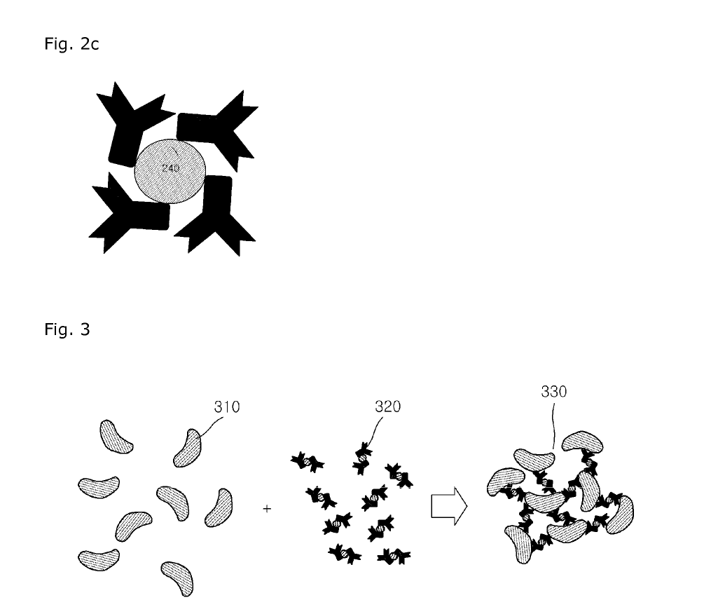

In the present invention, examples of the antibody include IgG, IgM, IgA, IgD and IgE immunoglobulins, with the preferred being IgG. The antibody may have a form shown in FIG. 2a and is characterized by having an Fab region 210 binding to antigen and an Fc region 220 which is involved in various regulatory processes. In addition, the antibody may be monoclonal or polyclonal.

Step of Forming Antibody-Protein Complex

This step is a step of forming a protein-antibody complex using a protein having the ability to bind to the Fc region of the antibody obtained in the antibody preparation step.

As described above, because the antibody has the Fab region binding to antigen and the Fc region which is involved in other regulatory processes, the protein-antibody complex can be formed by treating the antibody with a protein capable of binding to the Fc region of the antibody in a state in which the Fab region inducing the subsequent agglutination of blood cells (antigen) is exposed.

The protein having the ability to bind to the Fc region of the antibody may be protein A, protein G, or a mixture thereof. Protein G is a protein derived from the cell wall of Streptococci and has two Fc binding regions per molecule. Referring to FIG. 2b, a protein-antibody complex consisting of two antibodies bound to one protein G 230 may be formed. Meanwhile, protein A is a protein derived from the cell wall of Staphylococcus aureus and has four Fc binding regions per molecule. Referring to FIG. 2c, a protein-antibody antibody consisting four antibodies bound to one protein A 240 may be formed. Protein A and protein G are commercially available.

Because this protein-antibody complex is present in a state in which the Fab (antigen-binding portion) of the antibody is exposed, it is characterized in that it does not interfere with an antigen-antibody reaction with a specific antigen. Also, the protein-antibody complex has a particle size larger than that of a single antibody, and thus the size of an antigen-antibody complex which is formed upon contact of the complex with the blood cell (antigen) of blood will be increased, thus facilitating blood cell capture and plasma separation.

Stein of Agglutinating Blood Cells

This step is a step of agglutinating blood cells by allowing the antibody-protein complex to react with the subject's blood.

For the convenience of plasma separation, the plasma extraction method of the present invention may comprise, after the step of forming the antibody-protein complex, a step of applying the antibody-protein complex to the inside of a device for plasma separation and injecting the subject's blood into the device so as to react with the antibody-protein complex.

When the antibody-protein complex is applied to the inside of the device, the amount of antibody-protein complex applied may vary depending on the amount of blood injected. The ratio between the blood cells and the antibody-protein complex is preferably maintained at a constant level, and for example, the antibody-protein complex can be used such that 1-10 antibody-protein complexes react with one blood cell. In one embodiment, 5×10⁸ to 5×10⁹ antibody-protein complexes may be used to treat 10 ml of blood (about 5×10⁸ blood cells at a conventional blood cell concentration of 5×10⁷/ml).

When the antibody-protein complex is allowed to react with the subject's blood, the blood cells (antigen) bind to the Fab region (antigen binding portion) of the antibody to form an antigen-antibody complex, thereby inducing the agglutination of the blood cells. Herein, the reaction time may vary depending on the amount of blood injected, and it is preferably 3-30 minutes, and more preferably 5-10 minutes. The process of agglutinating blood cells will now be described in detail with reference to FIG. 3. Among the components of the subject's blood, blood cells 310 containing antigen bind to the Fab region of antibody-protein complexes 320, thereby forming a large blood cell aggregate 330.

Step of Separating Plasma

This step is a step of filtering the blood having the blood cell aggregate formed therein through a filter, thereby separating plasma from the blood.

The filter that is used in the present invention may have various structures made of various materials, as known in the field of plasma separation. Specifically, this filter may be in the form of a porous matrix made of a paper, glass fiber, ceramic, steel or polymer material.

Also, the porous matrix is not specifically limited as long as it has a pore size through which blood cell aggregates larger than single blood cells do not pass. The pore size of the porous matrix may preferably be 10-100 μm, and more preferably 20-50 μm. In this pore size range, accurate and rapid filtration of plasma is possible so that high plasma separation efficiency is achieved.

The plasma separation device according to one embodiment of the present invention is used to perform the plasma extraction method of the present invention in an easy manner. Specifically, the plasma separation device comprises a fluid channel comprising: a sample injection unit through which the blood of a subject is injected; a reaction unit to which a complex consisting of a blood cell-specific antibody of the subject and a protein having the ability to bind to the Fc region of the antibody is applied to induce the agglutination of blood cells; and a filter unit for filtering the blood to separate plasma from the blood.

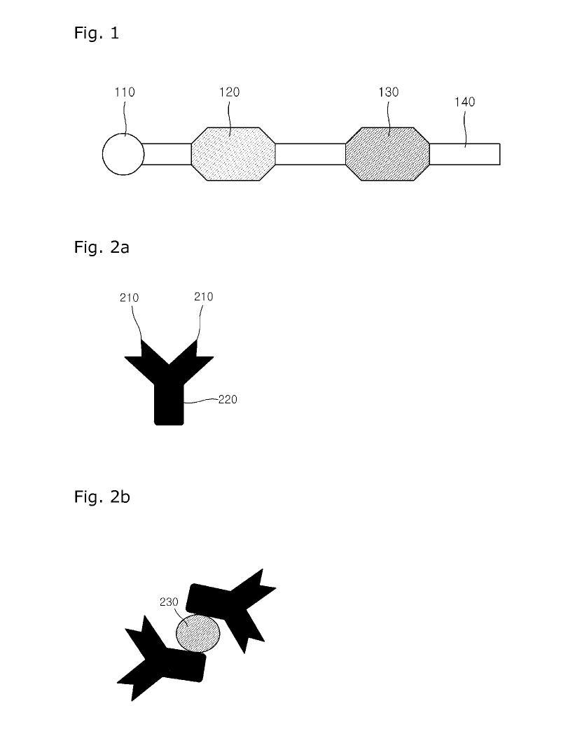

FIG. 1 shows the configuration of the plasma separation device. As shown therein, the plasma separation device comprises: a sample injection unit 110 into which blood is injected; a reaction unit 120 for inducing the agglutination of blood cells; and a filter unit 130 for filtering blood; wherein the units are connected with each other by a channel unit 140 and form a long channel through which a fluid passes.

The sample injection unit 110 is a unit through which the blood of a subject is injected. The blood can be injected into the sample injection unit 110 by a syringe, a cylinder, a pipette, a tube or the like, and the size of the injection unit can be adjusted in order to facilitate the injection of the blood.

The reaction unit 120 is a unit to which a complex consisting of a blood cell-specific antibody of the subject and a protein having the ability to bind to the Fc region of the antibody is applied to induce the agglutination of the blood cells of the subject. The amount of antibody-protein complex applied according to the amount of blood treated, and is not specifically limited. The antibody-protein complex may be applied not only to the reaction unit 120, but also to the sample injection unit 110.

In one embodiment of the present invention, the blood cell-specific antibody of the subject is preferably IgG, and the protein having the ability to bind to the Fc region of the antibody is preferably protein A, protein G, or a mixture thereof. Herein, the form of the complex of IgG with protein A or protein G is as described above for the plasma extraction method.

After the subject's blood has been injected through the sample injection unit 110, the agglutination of blood cells is induced in the reaction unit 120. When the antibody-protein complex is allowed to react with the blood, the blood cells (antigen) of the blood are agglutinated through the antibody-protein complex. Namely, the blood cells bind to the Fab region of the antibody present in the antibody-protein complex to cause an antigen-antibody reaction, thereby forming large blood cell aggregates. Specific details regarding the agglutination of blood cells are as described above.

The filter unit 130 is a unit serving to filter the blood having the blood cell aggregates formed therein to separate plasma from the blood. Herein, the filter unit 130 may comprise a single-layer or multilayer filter for capturing the agglutinated blood cells while passing only plasma. Also, the filter may be in the form of a porous filter made of a paper, glass fiber, ceramic, steel or polymer material. The pore size of the porous matrix may be 10-100 μm.

The inventive fluid channel comprising the sample injection unit, the reaction unit and the filter unit may be made of a plastic, glass, silicone or rubber material. For simple and easy treatment, the fluid channel is preferably made of a plastic material. Examples of the plastic material that may be used in the fluid channel include polydimethylsiloxane (PDMS), polymethylmethacrylate (PMMA), polycarbonate (PC), cycloolefin copolymers (COCs), polyamide (PA), polyethylene (PE), polypropylene (PP), polyphenylene ether (PPE), polystyrene (PS), polyoxymethylene (POM), polyetheretherketone (PEEK), polytetrafluoroethylene (PTFE), polyvinyl chloride (PVC), polyvinylidene fluoride (PVDF), polybutylene terephthalate (PBT), fluorinated ethylenepropylene (FEP), and perfluoralkoxyalkane (PFA).

The plasma separation device of the present invention may further comprise, at its end, a unit for analyzing biomarkers of the plasma. In this case, there is an advantage in that plasma separation and diagnosis are performed in a one-step process, thus making more rapid diagnosis.

In addition, the plasma separation device may be in the form of a plasma separation chip for performing rapid diagnosis using a small amount of blood.

Hereinafter, the construction and effect of the present invention will be described in further detail with reference to a preferred example. However, the following example is provided for a better understanding of the present invention, and the scope of the present invention is not limited thereto. The contents which are not described herein can be technically analogized by a person skilled in the art, and thus a description thereof will be omitted.

### EXAMPLE

### Extraction of Plasma Using Plasma Separation Device

To prepare an antibody specific for the blood cells of a subject (human), blood cells were inoculated into the abdominal cavity of a mouse, after which the antibody IgG specific for the human blood cells was separated from the mouse serum by immunoaffinity.

Specifically, 20 ml of human blood was collected and washed three times or more with physiological saline to remove plasma proteins. 1×10⁷ blood cells free from plasma proteins were diluted in 100 ml of physiological saline and inoculated into the abdominal cavity of a mouse four times or more at 3-week intervals so that a sufficient amount of antibody was formed in the mice. 7 days after the final inoculation, the mouse blood was collected, coagulated and centrifuged, and the supernatant serum was collected.

To separate only a human blood cell-specific antibody from the serum, 200 ml of the human blood was washed three times with physiological saline and mixed with 50 ml of the serum obtained from the mouse. The blood/serum mixture was incubated at room temperature for about 2 hours, and then centrifuged and washed five times with PBS to remove non-specific antibodies. The adhered antibody was collected using a low-pH technique.

After the final washing, 200 ml of extraction buffer (100 mM glycine (pH 2.5), 0.15 M NaCl) was added to and mixed with the blood cell precipitate. The mixture was allowed to stand at room temperature for about 2 minutes, and then centrifuged, and the supernatant was collected and neutralized with 20 ml of a neutralizing solution (1 M phosphate buffer (pH 8.0)), thereby separating the human blood cell-specific antibody from the mixture.

The IgG antibody thus obtained was mixed with protein A to form an antibody-protein complex consisting of four IgG bound to one protein A. Protein A used herein was purchased from Thermo Fisher Scientific Inc.

To separate plasma using the plasma separation device including the fluid channel comprising the sample injection unit, the reaction unit and the filter unit, the above-described antibody-protein complex was applied to the reaction unit. Herein, about 2.5×10⁹ antibody-protein complexes were applied to treat 10 ml of blood (about 5×10⁸ blood cells at a conventional blood cell concentration of 5×10⁷/ml) so that the blood cells and the antibody-protein complexes were bound to each other at a ratio of 1:5.

Then, 10 ml of the subject's blood was injected into the sample injection unit of the device to which the antibody-protein complex had been applied, after which it was allowed to stand at room temperature for 5 minutes so that the coagulation of the blood occurred in the reaction unit. Then, the reacted blood was filtered through the filter provided in the filter unit, thereby separating only plasma from the blood.

The state of the separated plasma was examined and, as a result, it could be seen that the plasma separation method according to the present invention makes it possible to separate plasma in a rapid and accurate manner without blood cell leakage or hemolysis.

As described above, according to the plasma extraction method of the present invention, the agglutination of blood cells in blood is induced to form large blood cell aggregates which facilitate the filtration of plasma. Thus, plasma can be separated from whole blood in high efficiency, and rapid plasma separation is possible, so that rapid diagnosis can be performed even with a small amount of blood. Therefore, the blood extraction method and the plasma separation device therefor can be advantageously used in the case in which plasma separation is required for rapid diagnosis with a small amount of blood.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A plasma extraction method comprising the steps of:
preparing a blood cell-specific antibody of a subject;
mixing the antibody with a protein having the ability to bind to the Fc region of the antibody, thereby forming an antibody-protein complex;
allowing the antibody-protein complex to react with the blood of the subject, thereby agglutinating the blood cells of the subject; and
filtering the reacted blood through a filter, thereby separating plasma from the blood.

2. The blood extraction method of claim 1, wherein the antibody is IgG, and the protein having the ability to bind to the Fc region of the protein is protein A, protein G, or a mixture thereof.

3. The blood extraction method of claim 2, wherein, if the protein having the ability to bind to the Fc region of the protein is protein G, the antibody-protein complex consists of two IgGs bound to one protein G, and if the protein is protein A, the antibody-protein complex consists of four IgGs bound to one protein A.

4. The blood extraction method of claim 1, wherein the plasma extraction method further comprises, after the step of forming the antibody-protein complex, a step of applying the antibody-protein complex to the inside of a device for plasma separation and injecting the subject's blood into the device so as to react with the antibody-protein complex.

5. A plasma separation device comprising a fluid channel, the fluid channel comprising:
a sample injection unit through which the blood of a subject is injected;
a reaction unit to which a complex consisting of a blood cell-specific antibody of the subject and a protein having the ability to bind to the Fc region of the antibody is applied to induce the agglutination of blood cells; and
a filter unit for filtering the blood to separate plasma from the blood.

6. The plasma separation device of claim 5, wherein the antibody is IgG, and the protein having the ability to bind to the Fc region of the protein is protein A, protein G, or a mixture thereof.

7. The plasma separation device of claim 5, wherein the fluid channel comprising the sample injection unit, the reaction unit and the filter unit is made of a plastic, glass, silicone or rubber material.

8. The plasma separation device of claim 5, wherein the filter unit comprises a single layer or multilayer filter for capturing the agglutinated blood cells and passing only the plasma, in which the filter is in the form of a porous matrix made of a paper, glass fiber, ceramic, steel or polymer material.

9. The plasma separation device of claim 8, wherein the porous matrix has a pore size of 10-100 μm.

10. The plasma separation device of claim 5, wherein the device further comprises, at its end, a unit for analyzing plasma biomarkers.

11. The plasma separation device of claim 5, wherein the device is in the form of a plasma separation chip.
